(19) United States
(12) Patent Application Publication
(10) Pub. No.: US 2007/0224458 A1
(43) Pub. Date: Sep. 27, 2007

(54) Magnetic recording medium

(75) Inventors: Katsuhiko Meguro, Odawara-shi (JP); Masatoshi Takahashi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/727,262

(22) Filed: Mar. 26, 2007

(30) Foreign Application Priority Data
Mar. 24, 2006 (JP) 2006-084028

(51) Int. Cl. G11B 5/708

(52) U.S. Cl. 428/842.3; 428/842.8; 428/847.3

(57) ABSTRACT

The present invention provides a magnetic recording medium having a magnetic layer formed on at least one surface of a nonmagnetic support, wherein the magnetic layer includes a ferrite ferromagnetic hexagonal powder having an average plate diameter of 5 to 50 nm or a fine ferromagnetic metal powder having an average major axis length of 20 to 100 nm together with a binder, and the nonmagnetic support is a composition of a polyester or copolyester having one or more of polytrimethylene 2,6-naphthalate, polytetramethylene 2,6-naphthalate, polypentamethylene 2,6-naphthalate and polyhexamethylene 2,6-naphthalate, in order to provides an excellent running stability, low error rates under various environment and an excellent electromagnetic transforming properties and reliability.

### BACKGROUND OF THE INVENTION

1. Field of the Invention

The present invention relates to a magnetic recording medium, more specifically a magnetic recording medium having a magnetic layer formed by dispersing a ferromagnetic fine powder and a binder on at least one surface of a nonmagnetic support and having an excellent electromagnetic transforming properties and reliability.

2. Description of the Related Art

In the field of magnetic recording, practical application of digital recording which suffers less degradation proceeds from conventional analog recording. Recording/reproducing apparatuses and magnetic recording media used for digital recording are required to achieve high image quality and high sound quality as well as downsizing and space saving. And since digital recording generally needs more signals to be recorded than analog recording, high density recording is demanded in digital recording.

Recently, reproducing heads which adopt magnetic resistance (MR) as a principle of operation have been also proposed. They are beginning to be used in hard disks, and application thereof for magnetic tapes has been proposed in Japanese Patent Application Laid-Open No. 8-227517.

The MR heads provide several-fold reproduction output as compared with conventional induction type magnetic heads and the MR heads, which do not use induction coils, substantially decrease device noise such as impedance noise, and accordingly larger S/N ratio can be now obtained by reducing noise by magnetic recording media. In other words, reduction of noise by magnetic recording media, which conventionally has been submerged in the device noise, will enable good recording and reproducing and improve high density recording characteristics.

In the meantime, as conventional coating type magnetic recording media, widely used are one having a magnetic layer in which iron oxide, Co-modified iron oxide, CrO₂, ferromagnetic metal powder or hexagonal crystal ferrite powder is dispersed in a binder and provided by coating on a nonmagnetic layer, or one further having a nonmagnetic layer between the magnetic layer and the nonmagnetic support.

Various devices can be considered in order to reduce noise in such a coating type magnetic recording medium, and it is particularly effective to decrease the size of ferromagnetic powder particles and recent magnetic bodies give an effect using fine ferromagnetic metal powders having an average major axis of 100 nm or less or ferromagnetic hexagonal crystal ferrite fine powders having an average plate diameter of 50 nm or less.

Furthermore, in order to achieve high density recording, high density packing using the above fine particle ferromagnetic powder, short wavelength recording of signals by super smoothing of the surface of magnetic recording medium etc., improvement in so-called planar recording density by narrowing the width of recording track, etc. as well as improvement in volume recording density by decreasing the thickness of magnetic recording medium are demanded.

Meanwhile, various types of nonmagnetic supports considered to be applicable to various fields of application such as packaging have been proposed in late years (For example, see Japanese Patent Application Laid-Open Nos. 6-271682, 2000-17159, 2003-313407, and 2004-269827). Of these, Japanese Patent Application Laid-Open No. 6-271682 relates to a production method of a polyester composition having tetramethylene naphthalate as a main repeating component. Japanese Patent Application Laid-Open No. 2000-17159 relates to a film in which polypropylene naphthalate is blended with 40% by weight or less of the other polyesters.

Japanese Patent Application Laid-Open No. 2003-313407 relates to a semiaromatic polyester compatible resin composition which is based on poly(ethylene naphthalate). Japanese Patent Application Laid-Open No. 2004-269827 relates to a composition of poly(trimethylene 2,6-naphthalate).

### SUMMARY OF THE INVENTION

However, although each of the above Japanese Patent Application Laid-Open Nos. 6-271682, 2000-17159, 2003-313407, and 2004-269827 relates to a polyester composition having naphthalene dicarboxylic acid as a main dicarboxylic acid ingredient, none of these specifications mention the use in the field of magnetic recording, and therefore it is judged that there is no idea of using the polyester composition in the field of magnetic recording.

In the meantime, if the thickness of a magnetic recording medium is decreased to a certain value for improving the volume recording density, it will cause deterioration in running endurance and dimension stability under the environment of high temperature and high humidity. In addition, there have been proposed methods of adjusting strength along the length and width of a conventionally known nonmagnetic support such as polyethylene terephthalate, polyethylene naphthalate and fully aromatic polyamide by stretching and materials having high strength such as aromatic polyimide and polybenzimidazole as new materials to maintain the running endurance and dimension stability, but productivity thereof is low and causes problems in practical use such as increased costs.

As described above, development of a magnetic recording medium which can effectively prevent increase in error rate under various environments such as high temperature and high humidity while satisfying running properties corresponding to a recent demand for high recording density has been requested.

The present invention has been made under the circumstances and an object thereof is provide a magnetic recording medium having an excellent running stability, low error rates under various environment and an excellent electromagnetic transforming properties and reliability.

The present invention, aiming at solving the above-mentioned problems, provides a magnetic recording medium having a magnetic layer formed on at least one surface of a nonmagnetic support, wherein the magnetic layer includes a ferrite ferromagnetic hexagonal powder having an average plate diameter of 5 to 50 nm or a fine ferromagnetic metal powder having an average major axis length of 20 to 100 nm and a binder and the nonmagnetic support is a composition of a polyester or copolyester having one or more of polytrimethylene 2,6-naphthalate, polytetramethylene 2,6-naphthalate, polypentamethylene 2,6-naphthalate and polyhexamethylene 2,6-naphthalate.

The present inventors intended to solve the above-mentioned problems and completed the magnetic recording medium of the present invention which can effectively prevent error rate from increasing under various environments such as high temperature and high humidity while satisfying running properties corresponding to recent demands for high recording density by constituting a nonmagnetic support of a polyester composition or copolyester composition having one or more of polytrimethylene 2,6-naphthalate, polytetramethylene 2,6-naphthalate, polypentamethylene 2,6-naphthalate and polyhexamethylene 2,6-naphthalate. The details thereof will be described later.

In addition, a magnetic layer may be provided on the surface(s) of the nonmagnetic support; and a nonmagnetic layer having a nonmagnetic powder and a binder may be provided between the nonmagnetic support and the magnetic layer.

In the present invention, the above nonmagnetic support preferably includes 1 to 40% by weight of polyethylene 2,6-naphthalate.

The nonmagnetic support preferably has a Young's modulus in the length direction of 6.0 to 11.0 GPa and a Young's modulus in the width direction of 6.0 to 11.0 GPa.

In addition, in the present invention, the support preferably has a temperature expansion coefficient of 0 to 20 ppm/° C. and a humidity expansion coefficient of 0 to 20 ppm/% RH.

The temperature expansion coefficient and humidity expansion coefficient of the nonmagnetic support as used herein are values obtained by applying force of 1.0 N to a tape of 12.7 mm (½ inch), determining deformation in the width direction under conditions of 45° C. and 10% RH, 10° C. and 10% RH, 29° C. and 80% RH, and 45° C. and 24% RH respectively, and calculating coefficients of expansion in the width direction by multiple regression analysis.

As described above, magnetic recording media having an excellent electromagnetic transforming properties and reliability can be provided according to the present invention.

### BRIEF DESCRIPTION OF THE DRAWING

FIGS. 1A and 1B are tables showing production conditions and results of evaluation for the Examples and Comparative Examples.

FIGS. 2A and 2B are other tables showing production conditions and results of evaluation for the Examples and Comparative Examples.

### DETAILED DESCRIPTION OF THE PREFERRED EMBODIMENTS

Hereinbelow, preferred embodiments of the magnetic recording media of the present invention are described in detail for each item.

### [Nonmagnetic Support]

The nonmagnetic support used for the present invention is preferably a single copolyester formed by polycondensation reaction of 2,6-naphthalene dicarboxylic acid with 1,3-trimethylene diol, 1,4-tetramethylene diol, 1,5-pentamethylene diol or 1,6-hexamethylene diol and subsequent biaxial stretching, or a polyester composition formed by blending two or more of these polyesters and subsequent biaxial stretching.

The polyester constituting the biaxially stretched polyester film of the present invention may be mixed with 40% by weight or less of polyethylene 2,6-naphthalate. When the mixed amount of polyethylene 2,6-naphthalate exceeds 40% by weight, the film forming properties which characterize the present invention are deteriorated and the strength of the biaxially stretched film cannot be improved. The mixed amount of polyethylene 2,6-naphthalate is preferably 35% by weight or less, and more preferably 30% by weight or less.

There is no particular limitation on the production method of the polyester of the present invention, which can be produced following conventionally known production methods of polyester. Examples of such methods include: the direct esterification process having directly esterifying a dicarboxylic acid component with a diol component; and the transesterification process having performing transesterification reaction between a dialkyl ester initially used as a dicarboxylic acid component and a diol component and subsequent polymerization by heating the resulting mixture under reduced pressure to remove the excessive diol component.

In these processes, a transesterification catalyst or a polymerization catalyst can be used or a heat-resistant stabilizer can be added if necessary. For the purpose of improving heat resistance, copolymerization can be effected with a bisphenol compound or a compound having a naphthalene ring or cyclohexane ring. The copolymerization ratio is preferably 1 to 20 mol % based on the dicarboxylic acid constituting the polyester.

In addition, one or two or more kinds of various additives such as coloration inhibitors, oxidation inhibitors, crystal nucleating agents, lubricants, stabilizers, antiblocking agents, UV absorbers, viscosity modifiers, defoaming clarifying agents, antistatic agents, pH adjusting agents, dyes and pigments may be added at any step of synthesis and melt-mixing.

The intrinsic viscosity of polyester of the present invention measured with a phenol/1,1,2,2-tetrachloroethane mixed solvent is preferably 0.4 or more and 0.7 or less. When the intrinsic viscosity is less than 0.4, degree of polymerization is low and the strength of the film cannot be increased, which results in frequent cleavage of the film at the stretching step in the production method, and, in addition, dimensional stability of the magnetic tape under high temperature and high humidity becomes insufficient and thus the condition is not preferable. On the other hand, when the intrinsic viscosity is more than 0.7, film forming properties and extending properties at film forming step, and slitting properties at slitting step deteriorate and thus the condition is not preferable. Preferable intrinsic viscosity of the polyester of the present invention is 0.4 or more and 0.7 or less from the above point of view. Further preferably, it is 0.5 or more and 0.6 or less.

When polytrimethylene 2,6-naphthalate, polytetramethylene 2,6-naphthalate, polypentamethylene 2,6-naphthalate, polyhexamethylene 2,6-naphthalate or polyethylene 2,6-naphthalate of the present invention is mixed, the method therefor is not particularly limited.

A process having adding each of the polymers at the end of polymerization and palletizing the mixture; a process including palletizing each of the polymers and then kneading them with a melt-mixer such as a uniaxial or biaxial kneader and palletizing the mixture; and a process including melt-mixing the respective pellets at the film forming step and performing film forming of the mixture as it is, and the like processes can be preferably used.

When a melt-mixer is used, pellets may be melt-mixed after they are combined, or two or more polyesters may be supplied under quantitative control into a kneader equipped with a metering feeder for subsequent melt mixing.

Conventionally known processes can be used to produce polyester films of the present invention. For example, polyester may be molten using a conventionally known extruder, extruded from an orifice into a sheet at a temperature of melting point (Tm) to Tm +70° C., and then rapidly cooled and solidified at a temperature of 40 to 90° C. to obtain a non-stretched film.

After that, this non-stretched film is stretched at a temperature around (Tg: glass transition temperature −10) to (Tg +70)° C., by a stretch ratio of 2.5 to 4.5, preferably 2.8 to 3.9 and then stretched in a direction perpendicular to the above direction at a temperature around Tg to (Tg +70)° C., by a stretch ratio of 4.5 to 8.0, preferably 4.5 to 6.0, and further stretched again if necessary in the length and/or width direction to obtain a biaxially oriented film.

Biaxial stretching may be performed at a temperature around (Tg −10) to (Tg +70)° C. at the same time. The total stretch ratio is typically 12 times or more, preferably 12 to 32 times, and more preferably 14 to 26 times in terms of area stretch ratio.

Then the biaxially oriented film is further subjected to heat setting crystallization at a temperature around (Tg +70) to (Tm −10)° C., for example, 180-250° C. and thereby imparted with excellent dimensional stability. The heat setting time is preferably 1 to 60 seconds. It is preferable that the heat contraction ratio is adjusted by relaxing at a ratio of 3.0% or less, further preferably 0.5 to 2.0% in the length and/or width direction by this heat setting treatment. Because the characteristics of the film such as surface properties, strength and heat contraction ratio vary depending on the stretching conditions and other production conditions, conditions may be appropriately set as required to produce the film.

The biaxially stretched polyester film of the present invention preferably has a Young's modulus in the length direction of 6.0 GPa to 11.0 GPa and a Young's modulus in the width direction of 6.0 GPa to 11.0 GPa.

If the Young's modulus in the length direction is less than 6.0 GPa, the film, when used as a magnetic tape, tends to be affected by the fluctuation of tension in the drive and may increase errors. If the Young's modulus in the width direction is less than 6.0 GPa, dimensional stability of the width direction of the magnetic tape is insufficient and the width of tape fluctuates under high temperature and high humidity, which makes it hard to take tracking and the condition is not preferable. If the Young's modulus in the width direction is more 11.0 GPa, the film tends to be broken during film production and in use as a magnetic tape and thus the condition is not preferable.

The polyester film of the present invention has an arithmetical mean roughness SRa (JIS B 0660-2001, ISO 4287-1997) measured by using a probe-style three-dimensional surface roughness meter of 1.0 to 8.0 nm, preferably, 1.5 to 7.0 nm. When SRa is less than 1.0 nm, the film, when made into a magnetic tape, tends to stick to the running system, and thus lacks in running properties; on the other hand, when SRa is more than 8.0 nm, the film, when made into a magnetic tape, lacks in output and thus the condition is not preferable.

The temperature expansion coefficient of the polyester film of the present invention is preferably 0 ppm/° C. or more and 20 ppm/° C. or less. 0 to 18 ppm/° C. is further preferable. When it is more than 20 ppm/° C., the width of tape significantly fluctuates under high temperature, which makes it hard to take tracking and the condition is not preferable.

The humidity expansion coefficient of the polyester film in the present invention is preferably 0 ppm/% RH or more and 20 ppm/% RH or less. 0 to 18 ppm/% RH is further preferable. When it is more than 20 ppm/% RH the width of tape significantly fluctuates under high humidity, which makes it hard to take tracking and the condition is not preferable.

In addition, the polyester film of the present invention is preferably formed by alternatively laminating two different polyester films different in the kind, average particle diameter and/or content of the fine particles for the purpose of adjusting the surface roughness of a monolayer or magnetic layer forming surface (side A) and the other side (side B). As for a method of laminating polyester film layers, coextrusion method is preferably used. On that occasion, it is preferable that the thickness of the polyester film layer forming side B is ½ to 1/10 of the whole thickness of the film.

The polyester which forms side A of the polyester film of the present invention desirably contains 0.1% by weight or less, preferably 0.06% by weight or less of fine particles having an average particle diameter of 30 to 150 nm, preferably 40 to 100 nm. As for this fine particle, silica, calcium carbonate, alumina, poly acryl particles, polystyrene particles can be preferably used.

Examples of the fine particles used in the polyester film layer forming side B include calcium carbonate, silica, alumina, polystyrene particles, silicone resin particles. The average particle diameter is preferably 80 to 800 nm, more preferably 100 to 700 nm, and the addition amount is preferably 0.05 to 1.0% by weight, more preferably 0.08 to 0.8% by weight.

### [Magnetic Material]

### <Ferromagnetic Metal Powder>

It is known that ferromagnetic metal powder used for the nonmagnetic layer of the magnetic recording medium of the present invention is excellent in high density magnetic recording characteristics and thus a magnetic recording medium having excellent electromagnetic transforming properties can be obtained.

The average major axis length of the ferromagnetic metal powder used for the magnetic layer of the magnetic recording medium of the present invention is 20 to 60 nm, but it is preferably 25 to 50 nm, and it is more preferably 30 to 45 nm. If the average major axis length of the ferromagnetic metal powder is more than 20 nm, deterioration in magnetic properties by thermal fluctuation can be suppressed effectively. In addition, when the he average major axis length is 60 nm or less, good S/N ratio can be obtained while maintaining low noise.

The average major axis length of the ferromagnetic metal powder can be determined as the average of values obtained by combining a method including taking a micrograph of the ferromagnetic metal powder by a transmission electron microscope (TEM) and directly reading the minor axis diameter and major axis diameter of the ferromagnetic metal powder from the micrograph; and a method of reading including tracing the transmission electron microscope micrograph by an image analysis device (product name: IBASSI, manufactured by Karl Zeiss).

The ferromagnetic metal powder used in the magnetic layer of the magnetic recording medium of the present invention is not particularly limited as far as the main component is FE but a ferromagnetic alloy powder containing α-Fe as a main component is preferable.

Such a ferromagnetic powder may contain atoms such as Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr and B in addition to the predetermined atom. Those containing at least one of Al, Si, Ca, Y, Ba, La, Nd, Co, Ni and B in addition to α-Fe are preferable, and those containing Co, Al, Y are particularly preferable. More specifically, those containing 10 to 40 atom % of Co, 2 to 20 atom % of Al and 1 to 15 atom % of Y for Fe are preferable.

The ferromagnetic metal powder may be preliminarily treated with dispersing agent, lubricant, surfactant, antistatic agent and the like mentioned later before it is dispersed. In addition, the ferromagnetic metal powder may contain a little amount of water, hydroxides or oxides. The water content of the ferromagnetic metal powder is preferably 0.01 to 2%. It is preferable to optimize the water content of the ferromagnetic metal powder depending on a kind of binder.

It is preferable to optimize pH of the ferromagnetic metal powder by a combination with a binder to be used. The range is typically 6 to 12 and preferably 7 to 11. In addition, there are cases that the ferromagnetic powder contains soluble inorganic ions such as Na, Ca, Fe, Ni, Sr, NH₄, SO₄, Cl, NO₂, NO₃. It is substantially preferable that these are not contained. If the total of each ion is on the order of 300 ppm or less, they do not influence the characteristics. In addition, it is preferable that ferromagnetic powder used for the present invention has fewer pores, and the value is 20% by volume or less and more preferably 5% by volume or less.

The crystallite size of the ferromagnetic metal powder is 8 to 20 nm, but it is preferably 10 to 18 nm and more preferably 12 to 16 nm. This crystallite size is an average value determined from the width of diffraction peak at half height by Scherrer method using an X-ray diffraction device (RINT2000 series manufactured by Rigaku Denki) under conditions of radiation source: CuKα1, tube voltage: 50 kV, tube current: 300 mA.

The specific surface area by BET method (S BET) of ferromagnetic metal powder is preferably 30 m²/g or more and 50 m²/g or less and more preferably 38 to 48 m²/g. If the specific surface area falls within this range, good surface properties and low noise are compatibly enabled.

It is preferable to optimize pH of the ferromagnetic metal powder by a combination with a binder to be used. The range is typically 4 to 12 and preferably 7 to 11. The ferromagnetic metal powder may be surface treated with Al, Si, P or these oxides if necessary. The amount thereof is 0.1 to 10% for the ferromagnetic metal powder. The surface treatment lowers adsorption of lubricant such as fatty acid to 100 mg/m² or less and therefore it is preferable.

In addition, there are cases that the ferromagnetic powder contains soluble inorganic ions such as Na, Ca, Fe, Ni and Sr but if the amount is 200 ppm or less, they scarcely influence the characteristics in particular. In addition, it is preferable that ferromagnetic powder used for the present invention has fewer pores and the value is 20% by volume or less and more preferably 5% by volume or less.

The shape of the ferromagnetic metal powder may be any form of needle, granule, piece of rice or plate as long as it satisfies characteristics mentioned above in relation to the particle size but it is particularly preferable to use ferromagnetic powder in the form of needle. In the case of needle-shaped ferromagnetic metal powder, the needle-shaped ratio is preferably 4 to 12, more preferably 5 to 12.

Hc of the ferromagnetic metal powder is preferably 159.2 to 238.8 kA/m, and more preferably it is 167.2 to 230.8 kA/m. The saturated magnetic flux density is preferably 150 to 300 T·m, and more preferably is 160 to 290 T·m. In addition, as is preferably 140 to 170 A/m²/kg, and more preferably is 145 to 160 A/m²/kg.

The smaller SFD (switching field distribution) of the magnetic material in itself is, the more preferable, and it is preferably 0.8 or less. When SFD is 0.8 or less, electromagnetic transforming properties is good and output is high, and, in addition, magnetization turning over is sharp, peak shift shrinks, and therefore it is suitable for high density digital magnetic recording. Methods for decreasing Hc distribution in the ferromagnetic metal powder include a method of improving particle size distribution of geothite, a method of using monodisperse α-Fe₂O₃, a method of preventing sintering among particles, etc.

Ferromagnetic metal powder obtained by conventionally known production method can be used and examples thereof include the following processes. That is, a method of reducing hydrated iron oxide or iron oxide subjected to sintering preventing treatment with a reducing gas such as hydrogen to obtain Fe or Fe—Co particles and the like; a method of reducing with a composite organic salt (mainly, oxalate) and a reducing gas such as hydrogen; a method of heat decomposing a metal carbonyl compound; a method of reducing by adding a reducing agent such as sodium borohydride, hypophosphite or hydrazine to an aqueous solution of a ferromagnetic metal; and a method of vaporizing a metal in an inert gas of low pressure to obtain a fine powder, etc.

The thus obtained ferromagnetic metal powder is subjected to a conventional slow oxidation treatment. A process, by which demagnetization amount is small, including reducing hydrated iron oxide or iron oxide with a reducing gas such as hydrogen and forming an oxide film on the surface by controlling partial pressures of oxygen containing gas and an inert gas, temperature and length of time is preferred.

### <Ferrite Ferromagnetic Hexagonal Powder>

Ferrite ferromagnetic hexagonal powder has hexagon-shaped magnetoplumbite structure and has an extremely large uniaxial crystal magnetic anisotropy and a very high coercive force (Hc). On this account, the magnetic recording medium using ferrite ferromagnetic hexagonal powder is excellent in chemical stability, corrosion resistance and abrasion resistance, and can attain a smaller magnetic spacing due to a higher density, a thinner film, a higher C/N and a higher resolution.

The average plate diameter of ferrite ferromagnetic hexagonal powder is 5 to 40 nm, but preferably it is 10 to 38 nm, and more preferably 15 to 36 nm. Generally, it is necessary not only to lower the noise level and but also decrease the average plate diameter of the ferrite ferromagnetic hexagonal powder when recording media with an increased track density are played back using a magnetoresistive head.

In addition, the average plate diameter of hexagonal crystal ferrite is preferably as small as possible from a viewpoint of decreasing magnetic spacing. However, magnetization becomes unstable due to thermal fluctuation if the average plate diameter of ferrite ferromagnetic hexagonal powder is too small. For this reason, the lower limit of the average plate diameter of ferrite ferromagnetic hexagonal powder to be used in the magnetic layer of the magnetic recording medium of the present invention is prescribed to be 5 nm. If the average plate diameter is 5 nm or more, there is little influence by thermal fluctuation and stable magnetization can be obtained.

On the other hand, the upper limit of the average plate diameter of ferrite ferromagnetic hexagonal powder is prescribed to be 40 nm. If the average plate diameter is 40 nm or less, degradation of electromagnetic conversion properties due to increase of the noise level can be suppressed and it is particularly suitable for reproducing recording media with a magnetoresisitive (MR) head. The average plate diameter of the ferrite ferromagnetic hexagonal powder can be determined as an average value by combining a method of taking a micrograph of ferrite ferromagnetic hexagonal powder by transmission electron microscope and directly reading the average plate diameter of the ferromagnetic hexagonal ferrite from the micrograph, and a method of reading by tracing the transmission electron microscope micrograph by an image analysis device (product name: IBASSI, manufactured by Karl Zeiss).

Examples of the ferrite ferromagnetic hexagonal powder contained in the magnetic layer of the present invention include respective substitution products of barium ferrite, strontium ferrite, lead ferrite, calcium ferrite, and Co substitution product. More specifically, barium ferrite and strontium ferrite of a magnetoplumbite type, magnetoplumbite-type ferrite whose particle surface is coated with spinel, and further barium ferrite and strontium ferrite of a magnetoplumbite type partially containing spinel phase are included.

Atoms such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge and Nb may be contained in addition to the predetermined atom. Generally those added with elements such as Co—Zn, Co—Ti, Co—Ti—Zr, Co—Ti—Zn, Ni—Ti—Zn, Nb—Zn—Co, Sb—Zn—Co, Nb—Zn can be used. In addition, there are materials containing specific impurities depending on raw materials and/or production method.

The particle size of ferrite ferromagnetic hexagonal powder is 5 to 40 nm, preferably 10 to 38 nm, and more preferably 15 to 36 nm in terms of average plate diameter as stated above. The average plate thickness is 1 to 30 nm, preferably 2 to 25 nm, and more preferably 3 to 20 nm. The tabular ratio (plate diameter/plate thickness) is 1 to 15, and it is preferably 1 to 7. If the tabular ratio is 1 to 15, sufficient orientation is obtained while maintaining high filling properties in the magnetic layer and increase of noise can be suppressed by stacking among particles.

The specific surface area by BET method in the above range of particle size is 10 to 200 m²/g. This specific surface area agrees with the value calculated from the particle plate diameter and plate thickness.

As for the distribution of particle plate diameter and plate thickness of ferrite ferromagnetic hexagonal powder, typically the narrower it is, the more preferable. It is difficult to quantify the particle plate diameter and plate thickness, but they can be compared by measuring 500 particles from a transmission electron microscope micrograph of particles at random.

The distribution of the particle plate diameter and plate thickness is not a normal distribution in many cases, but calculation of the ratio of the standard deviation to the average size gives an expression, σ/average size=0.1 to 2.0. In order to make the particle size distribution sharp, it is performed to make the particle generating reaction system as uniform as possible and also to subject the generated particles to distribution improvement treatment. For example, a method of selectively dissolving super fine particles in an acid solution is known.

The Hc of the hexagonal crystal ferrite particle can be prescribed to be a range of 159.2 to 238.8 kA/m, and preferably it is 175.1 to 222.9 kA/m, and more preferably 183.1 to 214.9 kA/m. It is, however, preferably 159.2 kA/m or less when the saturated magnetization (σs) of the head exceeds 1.4T. Hc can be controlled by particle size (plate diameter and plate thickness), kinds and amount of component elements, substitution sites of elements, conditions of particle generating reaction, etc.

The σs of the hexagonal crystal ferrite particle is 40 to 80 A·m²/kg. A higher σs is more preferable, but σs tends to decrease as particles become finer. In order to improve as, compounding spinel ferrite in magnetoplumbite ferrite and selecting kind and addition amount of component elements are well known. W type hexagonal crystal ferrite can be also used. The particle surface of the magnetic material may be treated with a dispersion medium and/or a compatible with the polymer when the magnetic material is dispersed.

As the surface treatment agent, inorganic compounds and organic compound are used. Typical examples of such compounds include oxides and hydroxides of Si, Al, P, etc., various silane coupling agents, various titanium coupling agents. The amount of addition is 0.1 to 10% by mass for the mass of the magnetic material. pH of the magnetic material is also important for dispersion. Typically, the optimal value is around 4 to 12 depending on the dispersion medium and the polymer but around 6 to 11 is selected from chemical stability and storage stability of the medium. Water contained in the magnetic material also influences dispersion. There are optimal values depending on the dispersant and the polymer but typically selected is 0.01 to 2.0%.

The production method of the ferrite ferromagnetic hexagonal powder includes the following methods, but the production method is not limited in the present invention. 1) glass crystallization method including mixing barium oxide, iron oxide and a metallic oxide which substitutes iron and boron oxide and the like as a glass forming substance so that they form a desired ferrite composition, then melting and quickly cooling the mixture to form an amorphous substance, and then, after performing heat treatment again, performing washing and crushing to obtain barium ferrite crystal powder; 2) hydrothermal reaction method including neutralizing with an alkali an aqueous metal salt solution having a composition of barium ferrite, removing by-products, and then, after heating a liquid phase at 100° C. or more, performing washing, drying and crushing to obtain barium ferrite crystal powder; and 3) coprecipitation method including neutralizing with an alkali an aqueous metal salt solution having a composition of barium ferrite, removing by-products, and then, drying and treating at 1100° C. or less, performing crushing to obtain barium ferrite crystal powder.

The ferrite ferromagnetic hexagonal powder may be surface treated with Al, Si, P or these oxides if necessary. The amount thereof is 0.1 to 10% for the ferromagnetic powder. The surface treatment lowers adsorption of lubricant such as fatty acid to 100 mg/m² or less and therefore it is preferable. There are cases that the ferromagnetic powder contains soluble inorganic ions such as Na, Ca, Fe, Ni and Sr. It is substantially preferable that these are not contained but if the amount is 200 ppm or less, they scarcely influence the characteristics in particular.

### [Nonmagnetic Powder]

The magnetic recording medium of the present invention has a nonmagnetic layer containing a binder and a nonmagnetic powder on the nonmagnetic support. The nonmagnetic powder usable in the nonmagnetic layer may be either an inorganic substance or an organic substance. Carbon black and the like can be also used. Examples of the inorganic substance include metals, metal oxides, metal carbonates, metal sulfates, metal nitrides, metal carbides and metal sulfides.

Specifically, one or two or more in combination of titanium oxide such as titanium dioxide, cerium oxide, tin oxide, tungsten oxide, ZnO, ZrO₂, SiO₂, Cr₂O₃, α-alumina having an α-ratio of 90 to 100%, β-alumina, γ-alumina, α-iron oxide, geothite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, titanium carbide can be used. Preferred are α-iron oxide and titanium oxide.

The shape of the nonmagnetic powder may be any form of needle, sphere, polygon and plate. The crystallite size of the nonmagnetic powder is preferably 4 nm to 1 μm, and more preferably 40 to 100 nm. If the crystallite size is in a range of 4 nm to 1 μm, the powder has no difficulty in dispersion and has suitable surface roughness and therefore it is preferable. The average particle diameter of such a nonmagnetic powder is preferably 5 nm to 2 μm but, if necessary, similar effect can be attained by combining nonmagnetic powders having different average particle diameters or widening the particle size distribution of even a single type of nonmagnetic powder. The particularly preferable average particle diameter of nonmagnetic powder is 10 to 200 nm. When it is in a range of 5 nm to 2 μm, the powder is good in dispersion and has suitable surface roughness and therefore it is preferable.

The specific surface area of nonmagnetic powder is 1 to 100 m²/g, and preferably it is 5 to 70 m²/g, and more preferably 10 to 65 m²/g. When it is in a range of 1 to 100 m²/g, the powder has suitable surface roughness, and enables to be dispersed with a desired amount of binder and therefore it is preferable.

The oil absorption using dibutyl phthalate (DBP) is preferably 5 to 100 ml/100 g, preferably 10 to 80 ml/100 g and more preferably 20 to 60 ml/100 g. The specific weight is 1 to 12, preferably 3 to 6.

The tap density is 0.05 to 2 g/ml, preferably 0.2 to 1.5 g/ml. If the tap density is in a range of 0.05 to 2 g/ml, there are few scattered particles, and the powder is easy in handling and tends to be hard to adhere to the device.

The pH of the nonmagnetic powder is preferably 2 to 11 and the pH 6 to 9 is particularly preferable. If the pH is in a range of 2 to 11, friction properties does not significantly increase under high temperature and high humidity, or by liberation of fatty acid.

The water content of the nonmagnetic powder is 0.1 to 5% by mass, preferably 0.2 to 3% by mass, and more preferably 0.3 to 1.5% by mass. If the water content is in a range of 1 to 5% by mass, dispersion is good, and viscosity of the coating composition after dispersion is stable and therefore it is preferable. The ignition loss is preferably 20% by mass or less, and the smaller the ignition loss is, the more preferable.

If the nonmagnetic powder is inorganic powder, the Mohs' hardness is preferably 4 to 10. If Mohs' hardness is in a range of 4 to 10, durability can be secured. The adsorption of stearic acid to the nonmagnetic powder is 1 to 20 μmol/m², preferably 2 to 15 μmol/m².

The heat of wetting to water of nonmagnetic powder at 25° C. is in a range of 200 to 600 erg/cm². Solvents having a heat of wetting in this range can be used. The suitable amount of water molecules on the surface at 100 to 400° C. is 1 to 10 molecules/100A. It is preferable that the pH of isoelectric point in water is between 3 and 9.

The surface of these nonmagnetic powders is preferably surface treated with Al₂O₃, SiO₂, TiO₂, ZrO₂, SnO₂, Sb₂O₃ and ZnO. Al₂O₃, SiO₂, TiO₂ and ZrO₂ are particularly preferable for dispersibility and Al₂O₃, SiO₂ and ZrO₂ are more preferable. These may be used in combination or may be used singly.

In addition, surface treatment layer in which coprecipitation has been performed depending on the purpose may be used, and a process having treating with alumina first and then treating the surface layer with silica or a process of vice versa may be adopted. The surface treatment layer may be made into a porous layer depending on the purpose, but generally a homogeneous and dense layer is preferable.

Specific examples of the nonmagnetic powder used for the nonmagnetic layer of the present invention include Nanotite manufactured by Showa Denko, HIT-100 and ZA-G1 manufactured by Sumitomo Chemical, DPN-250, DPN-250BX, DPN-245, DPN-270BX, DPB-550BX, DPB-550RX manufactured by Toda Kogyo, titanium oxides TTO-51B, TTO-55A, TTO-55B, TTO-55C, TTO-55S, TTO-55D, SN-100, MJ-7, α-iron oxide E270, E271 and E300 manufactured by Ishihara Sangyo, STT-4D, STT-30D, STT-30, STT-65C manufactured by Titan Kogyo, MT-100S, MT-100T, MT-150W, MT-500B, T-600B, T-100F, T-500HD manufactured by Tayca, FINEX-25, BF-1, BF-10, BF-20, ST-M manufactured by Sakai Chemical Industries, DEFIC-Y and DEFIC-R manufactured by Dowa Metals and Mining, AS2BM and TiO₂P25 manufactured by Nippon Aerosil, 100A and 500A manufactured by Ube Industries, Y-LOP manufactured by Titan Kogyo and sintered products thereof. Particularly preferable nonmagnetic powders are titanium dioxide and α-iron oxide.

Organic powders can be added in the nonmagnetic layer depending on the purpose. Examples of the organic powders include acryl styrene resin powder, benzoguanamine resin powder, melamine resin powder, phthalocyanine pigment, but polyolefin resin powder, polyester resin powder, polyamide resin powder, polyimide resin powder, polyfluoroethylene resin can be also used for such an organic powder.

### [Binder]

The binder used for the magnetic layer of the present invention is a conventionally known thermoplastic resin, thermoset resin, reactive type resin or a mixture thereof. Examples of the thermoplastic resin include a polymer or copolymer having, as a constitutional unit, vinyl chloride, vinyl acetal, vinyl alcohol, maleic acid, acrylic acid, acrylate esters, vinylidene chloride, acrylonitrile, methacrylic acid, methacrylate esters, styrene, butadiene, ethylene, vinyl butyral, vinyl acetal, vinyl ether, etc., polyurethane resin and various rubber resins.

Examples of the thermoset resin and reactive type resin include phenol resin, epoxy resin, polyurethane curing type resin, urea resin, melamine resin, alkyd resin, acryl reaction resin, formaldehyde resin, silicone resin, epoxy-polyamide resin, a mixture of polyester resin and isocyanate prepolymer, a mixture of polyester polyol and polyisocyanate, a mixture of polyurethane and polyisocyanate.

The thermoplastic resin, thermoset resin and reactive type resin are respectively described in detail in “Plastic Handbook” published by Asakura Shoten. When an electron radiation curing type resin is used for the magnetic layer, not only film coating strength is improved and durability is enhanced, but also the surface becomes smooth and electromagnetic transforming properties are also further improved.

The above-mentioned resin can be used singly or in combination thereof. Above all, it is preferable to use polyurethane resin, and it is further preferable to use a polyurethane resin obtained by reacting hydrogenated bisphenol A, a cyclic structural body such as polypropylene oxide addition product with hydrogenated bisphenol A, a polyol having an alkylene oxide chain having a molecular weight of 500 to 5000, a polyol having a cyclic structure and a molecular weight of 200 to 500 as a chain extender and an organic diisocyanate compound and introducing a hydrophilic polar group; a polyurethane resin obtained by reacting a aliphatic dibasic acid such as succinic acid, adipic acid and sebacic acid, a polyester polyol having an aliphatic diol which has an alkyl side-chain but does not have a cyclic structure such as 2,2-dimethyl-1,3-propanediol, 2-ethyl-2-butyl-1,3-propanediol, 2,2-diethyl-1,3-propanediol, an aliphatic diol having an alkyl side-chain with 3 or more carbon atoms such as 2-ethyl-2-butyl-1,3-propanediol and 2,2-diethyl-1,3-propanediol as a chain extender and an organic diisocyanate compound and introducing a hydrophilic polar group; or a polyurethane resin obtained by reacting a cyclic structural body such as dimer diol and a polyol compound having a long alkyl chain and an organic diisocyanate and introducing a hydrophilic polar group.

The average molecular weight of the polyurethane resin having a polar group used in the present invention is preferably 5000 to 100000, and more preferably 10000 to 50000. If the average molecular weight is 5000 or more, there is no deterioration in physical strength such that the obtained magnetic film coating is fragile, and the durability of the magnetic recording medium is not affected and therefore it is preferable. If the molecular weight is 100000 or less, dispersibility is good because solubility to a solvent does not deteriorate. In addition, operability is good and handling is easy because the viscosity of the coating composition in the predetermined density does not increase.

Examples of the polar group contained in the above polyurethane resin include —COOM, —SO₃M, —OSO₃M, —P═O(OM)₂, —O—P═O(OM)₂ (wherein M is a hydrogen atom or an alkali metal salt base), —OH, —NR₂, —N+R₃ (wherein R is a hydrocarbon group), epoxy group, —SH, —CN, and the resin in which at least one of these polar groups are introduced by copolymerization or addition reaction can be used.

When the polyurethane resin having a polar group has an OH group, it is preferable that the resin has a branched OH group in respect of curability and durability, and preferably 2 to 40 branched OH groups per one molecule, and more preferably 3 to 20 groups per one molecule. The amount of such a polar group is 10⁻¹ to 10⁻⁸ mol/g, and preferably 10⁻² to 10⁻⁶ mol/g.

Specific examples of binder include VAGH, VYHH, VMCH, VAGF, VAGD, VROH, VYES, VYNC, VMCC, XYHL, XYSG, PKHH, PKHJ, PKHC and PKFE manufactured by Union Carbide, MPR-TA, MPR-TA5, MPR-TAL, MPR-TSN, MPR-TMF, MPR-TS, MPR-TM and MPR-TAO manufactured by Nissin Chemical Industry, 1000W, DX80, DX81, DX82, DX83 and 100FD manufactured by Denki Kagaku Kogyo, MR-104, MR-105, MR110, MR100, MR555 and 400X-10A manufactured by Nippon Zeon, Nipporan N2301, N₂₃O₂ and N2304 manufactured by Nippon Polyurethane Industry, PANDEX T-5105, T-R3080 and T-5201, BURNOCK D-400, D-210-80 and CRYSBON 6109 and 7209 manufactured by Dainippon Ink and Chemicals, Byron UR8200, UR8300, UR8700, RV530, RV280 manufactured by Toyobo, Daiferamine 4020, 5020, 5100, 5300, 9020, 9022, 7020 manufactured by Dainichiseika Color & Chemicals Manufacturing, MX5004 manufactured by Mitsubishi Kasei, Sunprene SP-150 manufactured by Sanyo Chemical Industries, Saran F310 and F210 manufactured by Asahi Chemical Industry.

The addition amount of the binder used for the magnetic layer of the present invention is in a range of 5 to 50% by mass, preferably in a range of 10 to 30% by mass for mass of ferromagnetic powder (ferromagnetic metal powder or ferrite ferromagnetic hexagonal powder). When polyurethane resin is used, it is preferable to use 2 to 20% by mass in combination of 2 to 20% by mass of polyisocyanate, but, for example, when head corrosion occurs by a very small amount of dechlorination, only polyurethane or only polyurethane and isocyanate can be used.

When vinyl chloride resin is used as other resin, it is preferably used in a range of 5 to 30% by mass. In the present invention, when polyurethane is used, it has preferably a glass transition temperature of −50 to 150° C., preferably 0 to 100° C.; a breaking stretching of 100 to 2000%; stress at rupture of 0.49 to 98 MPa and a breakdown point of 0.49 to 98 MPa.

The magnetic recording medium to be used by the present invention includes a nonmagnetic layer and at least one magnetic layer. Therefore, the amount of the binder, the amount of vinyl chloride resin, polyurethane resin, polyisocyanate or other resin occupying in the binder, the molecular weight of each resin constituting the magnetic layer, the amount of polar groups or physical properties of resin as mentioned above, etc. can be made different between the nonmagnetic layer and each magnetic layer as necessary, or rather theses conditions should be optimized in each of the layers and conventional technology relating to the multi-layered magnetic layer can be applied. For example, when the amount of binder is changed in each layer, it is effective to increase the amount of binder in the magnetic layer to reduce scratches of the surface of the magnetic layer, and increased amount of binder in the nonmagnetic layer imparts flexibility to improve head touch against the head.

Examples of polyisocyanate usable in the present invention include isocyanates such as tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate and triphenylmethane triisocyanate, product of these isocyanates with polyalcohols, polyisocyanates generated by condensation of isocyanates.

Product names of these isocyanates commercially available are Colonate L, Colonate HL, Colonate 2030, Colonate 2031, Millionate MR, Millionate MTL manufactured by Nippon Polyurethane Industry, Takenate D-102, Takenate D-110N, Takenate D-200, Takenate D-202 manufactured by Takeda Pharmaceutical, Desmodule L, Desmodule IL, Desmodule N, Desmodule HL manufactured by Sumitomo Bayer and these may be used singly or two or more of them in combination may be used for each of the layers making use of difference in curing reaction characteristics.

### [Other Additives]

Additives can be added to the magnetic layer in the present invention if necessary. Examples of additives include abrasive, lubricant, dispersing agent, mildewproofing agent, antistatic agent, oxidation inhibitor, solvent and carbon black.

As these additives, for example, molybdenum disulfide; tungsten disulfide; graphite; boron nitride; graphite fluoride; silicone oils; silicones having a polar group; fatty acid-modified silicones; fluorinated silicones; fluorinated alcohols; fluorinated esters; polyolefins; polyglycols; polyphenyl ethers; aromatic ring-containing organic phosphonic acids such as phenylphosphonic acid and their alkali metal salts; alkylphosphonic acids such as octylphosphonic acid and their alkali metal salts; aromatic phosphoric acid esters such as phenylphosphate and their alkali metal salts; alkylphosphoric acid esters such as octylphosphate and their alkali metal salts; alkylsulfonic acid esters and their alkali metal salts; fluorinated alkylsulfuric acid esters and their alkali metal salts; monobasic fatty acids with 10 to 24 carbon atoms (which may contain an unsaturated bond or be branched) such as lauric acid and their metal salts; monofatty acid esters, difatty acid esters, or polyfatty acid esters such as butyl stearate formed by a monobasic fatty acid having 10 to 24 carbon atoms (which may contain an unsaturated bond or be branched) and any one of mono- to hexahydric alcohols having 2 to 22 carbon atoms (which may contain an unsaturated bond or be branched), alkoxy alcohols having 12 to 22 carbon atoms (which may contain an unsaturated bond or be branched) and monoalkyl ethers of alkylene oxide polymers; fatty acid amides having 2 to 22 carbon atoms, and aliphatic amines having 8 to 22 carbon atoms, etc. can be used.

In addition to the above hydrocarbon group, those having an alkyl group, aryl group, aralkyl group substituted with a group other than a hydrocarbon group such as a nitro group, F, Cl, Br, CF₃, CCl₃, CBr₃ and the like halogen containing hydrocarbon group may be used. Further, nonionic surfactants such as those based on alkylene oxide, glycerin, glycidol, alkylphenol ethylene oxide adduct, cationic surfactants such as those based on cyclic amine, ester amide, quartenary ammonium salts, hydantoin derivatives, heterocycles, phosphoniums or sulfoniums, anionic surfactants such those containing an acidic group such as carboxylic acid, sulfonic acid and sulfuric ester group, ampholytic surfactants such as amino acids, aminosulfonic acids, sulfuric acid or phosphoric acid esters of amino alcohol, alkyl betaine types can be also used.

These surfactants are described in “Handbook of Surfactants” (published by Sangyo Tosho Co., Ltd.) in detail. These additives do not necessarily have to be pure, and may contain impurities such as isomers, unreacted compounds, by-products, decomposition products, oxides in addition to the main component. The content of these impurities is preferably 30% by mass or less and more preferably 10% by mass or less. Specific examples of these additives include products of Nippon Oil & Fats: NAA-102, castor oil hardened fatty acid, NAA-42, Cation SA, Nymeen L-201, Nonion E-208, Anone BF, Anone LG, products of Takemoto Oil & Fats: FAL-205, FAL-123, products of New Japan Chemical: Enujelv OL, products of Shin-Etsu Chemistry: TA-3, Lion Armour: Amide P, product of Lion: Duomin TDO, products of Nisshin Oil Mills: BA-41G, products of Sanyo Kasei: Profan 2012E, Newpol PE61, Ionet MS-400.

Carbon black can be mixed in the magnetic layer and the nonmagnetic layer of the present invention to lower the surface electrical resistance and obtain desired micro-Vickers hardness. The micro-Vickers hardness is typically 25 to 60 kg/mm², preferably 30 to 50 kg/mm², to control the contact with the head and can be measured with a film hardness gauge (HMA-400 manufactured by NEC) using a tetrahedron needle made of diamond having an edge corner of 80 degrees and a tip radius of 0.1 μm for the tip of indenting tool. The carbon black which can be used for the magnetic layer and the nonmagnetic layer includes furnace black for rubber, thermal black for rubber, black for colors and acetylene black.

Preferably, specific surface is 5 to 500 m²/g, DBP oil absorption is 10 to 400 ml/100 g, particle diameter is 5 to 300 nm, pH is 2 to 10, water content is 0.1 to 10% and tap density is 0.1 to 1 g/ml.

Specific examples of the carbon black which can be used for the nonmagnetic layer of the present invention include BLACKPEARLS 2000, 1300, 1000, 900, 905, 800 and 700, and VULCAN XC-72 manufactured by Cabot Corporation, #80, #60, #55, #50 and #35 manufactured by Asahi Carbon, #3050B, #3150B, #3250B, #3750B, #3950B, #2400B, #2300, #1000 #970B, #950, #900, #850B, #650B, #30, #40, #10B and MA-600 manufactured by Mitsubishi Chemical Corporation, CONDUCTEX SC, RAVEN8800, 8000, 7000, 5750, 5250, 3500, 2100, 2000, 1800, 1500, 1255, 1250, 150, 50, 40, 15 and RAVEN-MT-P manufactured by Columbia Carbon, and Ketjen Black EC manufactured by Akzo.

Carbon black subjected to a surface treatment with a dispersant, etc., grafting with a resin, or a partial surface graphitization may be used. The carbon black may be dispersed in binder beforehand before added to a magnetic paint. The carbon black may be used singly or in a combination. The carbon black is preferably used in an amount of 0.1 to 30% by mass based on the mass of the magnetic material.

The carbon black has the functions of preventing static charging of the magnetic layer, reducing the coefficient of friction, imparting light-shielding properties, and improving the film strength and such functions vary depending on the type of carbon black. Accordingly, it is of course possible in the present invention to change the type, amount and combination of these carbon blacks for the magnetic layer and the nonmagnetic layer according to the intended purpose on the basis of the above-mentioned various properties such as the particle size, oil absorption, electroconductivity and pH value, or rather they should be optimized for the respective layers. As for the carbon black which can be used for the magnetic layer of the present invention, for example, “Handbook of Carbon Black” ed. by Carbon Black Association can be consulted.

The organic solvent used in the present invention can be a known organic solvent. As the organic solvent, ketones such as acetone, methyl ethyl ketone, methyl isobutyl ketone, diisobutyl ketone, cyclohexanone, isophorone and tetrahydrofuran, alcohols such as methanol, ethanol, propanol, butanol, isobutyl alcohol, isopropyl alcohol and methylcyclohexanol, esters such as methyl acetate, butyl acetate, isobutyl acetate, isopropyl acetate, ethyl lactate and glycol acetate, glycol ethers such as glycol dimethyl ether, glycol monoethyl ether and dioxane, aromatic hydrocarbons such as benzene, toluene, xylene, cresol and chlorobenzene, chlorohydrocarbons such as methylene chloride, ethylene chloride, carbon tetrachloride, chloroform, ethylene chlorohydrin and dichlorobenzene, N,N-dimethylformamide, hexane, etc. can be used at any ratio.

These organic solvents do not necessarily have to be 100% pure, and may contain impurities such as isomers, unreacted compounds, by-products, decomposition products, oxides and moisture in addition to the main component. The content of these impurities is preferably 30% or less, and more preferably 10% or less.

The type of organic solvent used in the present invention is preferably the same in the magnetic layer and the nonmagnetic layer. The addition amount thereof may be changed. It is important that the stability of coating is enhanced by using a solvent having a high surface tension (cyclohexanone, dioxane and the like) in the nonmagnetic layer, specifically, the arithmetic mean value of the upper layer solvent composition should not be below the arithmetic mean value of the nonmagnetic layer solvent composition. It is preferable that the polarity is high to some extent to improve dispersibility, and that the solvent having a dielectric constant of 15 or more is contained at 50% or more in the composition of the solvent. The dissolution parameter is preferably 8 to 11.

The type and the amount of the dispersant, lubricant and surfactant used in the present invention can be changed as necessary in the magnetic layer and/or the nonmagnetic layer. For example, although not limited to only the examples illustrated here, the dispersant has the property of adsorbing or bonding via its polar group, and it is surmised that the dispersant adsorbs or bonds, via the polar group, to mainly the surface of the ferromagnetic powder in the magnetic layer and mainly the surface of the nonmagnetic powder in the nonmagnetic layer, and once adsorbed it is hard to desorb an organophosphorus compound from the surface of metal, metal compound, etc.

Therefore, since in the present invention the surface of the ferromagnetic powder (ferromagnetic metal powder and ferrite ferromagnetic hexagonal powder) or the surface of the nonmagnetic powder, are in a state in which they are covered with an alkyl group, an aromatic group, etc., the affinity of the ferromagnetic powder or the nonmagnetic powder toward the binder resin component increases and, furthermore, the dispersion stability of the ferromagnetic powder or the nonmagnetic powder is also improved.

With regard to the lubricant, since it is present in a free state, its exudation to the surface is controlled by using fatty acids having different melting points for the nonmagnetic layer and the magnetic layer or by using esters having different boiling points or polarity. The coating stability can be improved by adjusting the amount of surfactant added, and the lubrication effect can be improved by increasing the amount of lubricant added to the nonmagnetic layer.

All or a part of the additives used in the present invention may be added at any step of preparation of the coating solutions for magnetic layer or the nonmagnetic layer. For example, an additive may be blended with a ferromagnetic powder before a kneading step; it may be added during a kneading step involving the ferromagnetic powder, a binder, and a solvent; it may be added during a dispersing step; it may be added after the dispersing step; or it may be added immediately before coating.

### [Backcoat Layer and Adhesion-Enhancing Layer]

Generally, repeat running properties are strongly demanded of magnetic tapes employed in computer data recording as compared with audio and video tapes. To maintain such high running durability, a backcoat layer can be provided on the reverse side of the nonmagnetic support from the side on which the nonmagnetic layer and magnetic layer are provided.

The backcoat layer coating liquid can be prepared by dispersing an abrasive, an antistatic agent and a binder in an organic solvent. Various inorganic pigments and carbon black may be used as granular components. Nitrocellulose, phenoxy resin, vinyl chloride resin, polyurethane and other resins may be used singly or in combination as the binder.

An adhesion-enhancing layer may be provided on the nonmagnetic support to increase adhesive strength with a smoothing layer and/or a backcoat layer. A solvent-soluble substance may be used as in the adhesion-enhancing layer as follows: polyester resin, polyamide resin, polyamidoimide resin, polyurethane resin, vinyl chloride resin, vinylidene chloride resin, phenol resin, epoxy resin, urea resin, melamine resin, formaldehyde resin, silicone resin, starch, modified-starch compounds, alginic acid compounds, casein, gelatin, pullulan, dextran, chitin, chitosan, rubber latex, gum Arabic, funori, natural gum, dextrin, modified cellulose resin, polyvinyl alcohol resin, polyethylene oxide, polyacrylic acid resin, polyvinyl pyrrolidone, polyethyleneimine, polyvinyl ether, polymaleic acid copolymers, polyacrylamide, and alkyd resins, etc.

The thickness of the adhesion-enhancing layer is not particularly limited as far as it is 0.01 to 3.0 μm, preferably 0.02 to 2.0 μm, and more preferably 0.5 to 1.5 μm. The glass transition temperature of the resin used in the above adhesion-enhancing layer is preferably 30 to 120° C., more preferably 40 to 80° C. Blocking does not occur along edge surfaces when it is 0° C. or more and internal stress within the adhesion-enhancing layer is moderated and adhesive strength is good when it is 120° C. or less.

### [Layer Structure]

In the magnetic recording medium of the present invention, at least a magnetic layer is provided on at least one surface of a nonmagnetic support. The magnetic layer may include two or more layers as needed. Further, a backcoat layer is provided as needed on the surface of the reverse side of the nonmagnetic support. Still further, lubricant coating films and various coating films for protecting the magnetic layer may be provided as needed on the magnetic layer in the magnetic recording medium of the present invention. A nonmagnetic layer may be further provided as needed between the nonmagnetic support and the magnetic layer. Still further, an undercoating layer (adhesion-enhancing layer) may be provided between the nonmagnetic support and the nonmagnetic layer to improve adhesion between the coating films and the nonmagnetic support.

In the magnetic recording medium of the present invention, a magnetic layer may be provided on one side of the nonmagnetic support, but on both sides thereof. When a nonmagnetic layer is provided as needed between the nonmagnetic support and the magnetic layer, the nonmagnetic layer (lower layer) and the magnetic layer (upper layer) may be provided in such a manner that the lower layer is applied first, with the upper layer being applied while the lower layer is still wet, or after the lower layer is dried. Simultaneous or sequential wet coating is preferred from the viewpoint of production efficiency, but in the multilayer configuration of the present invention, since the upper layer and the lower layer can be simultaneously formed by simultaneous or sequential wet coating, surface treatment steps such as calendering step can be effectively utilized to improve the surface roughness of the upper magnetic layer even in the case of ultrathin layer.

In the magnetic recording medium of the present invention, the thickness of the nonmagnetic support is preferably 3 to 80 μm. In computer tapes, a nonmagnetic support having a thickness of 3.5 to 7.5 μm, preferably 3 to 7 μm is used. Further, when an undercoating layer is provided between the nonmagnetic support and the nonmagnetic layer or the magnetic layer, the thickness of the undercoating layer is 0.01 to 0.8 μm, preferably 0.02 to 0.6 μm. Further, when a backcoat layer is provided on the reverse side from the side on which the nonmagnetic layer and the magnetic layer are provided on the nonmagnetic support, the thickness thereof is 0.1 to 1.0 μm, preferably 0.2 to 0.8 μm.

The thickness of the magnetic layer is optimized depending on the saturation magnetization level and head gap length of the magnetic head used and the recording signal band, but is generally 10 to 100 nm, preferably 20 to 80 nm, and more preferably 30 to 80 nm. Further, the thickness fluctuation ratio of the magnetic layer is desirably within ±50%, preferably within ±40%. The magnetic layer includes at least one layer, but may be separated into two or more layers having different magnetic characteristics. Known multilayer magnetic layer configurations may be employed.

When a nonmagnetic layer is provided in the present invention, the thickness of the nonmagnetic layer is 0.02 to 3.0 μm, preferably 0.05 to 2.5 μm, and more preferably 0.1 to 2.0 μm. In the magnetic recording medium of the present invention, the nonmagnetic layer can effectively function so long as it is essentially nonmagnetic. For example, even when an impurity or an intentional little amount of magnetic material is contained, the effect of the present invention is exhibited and the configuration can be seen as being essentially identical to that of the magnetic recording medium of the present invention. The term “essentially identical” means that the residual magnetic flux density of the nonmagnetic layer is equal to or less than 10 T·m (100 G) or the coercive force is equal to or less than 7.96 kA/m (100 Oe), with the absence of a residual magnetic flux density and coercive force being preferred.

### [Physical Characteristics]

In the magnetic recording medium of the present invention, the saturation magnetic flux density of the magnetic layer is 100 to 300 T·m. Hc of the magnetic layer is 143.3 to 318.4 kA/m and preferably 159.2 to 278.6 kA/m. The coercive force distribution is preferably narrow, and the SFD and SFDr is 0.6 or less, preferably 0.2 or less.

The coefficient of friction of the magnetic recording medium of the present invention with the head is 0.5 or less, preferably 0.3 or less, over a temperature range of −10 to 40° C. and a humidity range of 0 to 95%. Intrinsic surface resistance is preferably 10⁴ to 10¹² Ω/sq on the magnetic surface and the charge potential is preferably within a range of −500 to +500 V.

The modulus of elasticity at 0.5% elongation of the magnetic layer is preferably 0.98 to 19.6 GPa in all in-plane directions. The breaking strength is preferably 98 to 686 MPa. The modulus of elasticity of the magnetic recording medium is preferably 0.98 to 14.7 GPa in all in-plane directions. The residual elongation is preferably 0.5% or less. The thermal shrinkage rate at any temperature equal to or less than 100° C. is preferably 1% or less, preferably 0.5% or less, and more preferably 0.2% or less.

The glass transition temperature of the magnetic layer (the peak loss elastic modulus of dynamic viscoelasticity measured at 1 Hz) is preferably 50 to 180° C., and that of the nonmagnetic layer is preferably 0 to 180° C. The loss elastic modulus preferably falls within a range of 1×10⁷ to 8×10⁸ Pa and the loss tangent is preferably 0.2 or less. Excessively high loss tangent tends to cause adhesion failures. It is preferable that these thermal and mechanical characteristics are substantially identical within 10% in all in-plane directions of the medium.

Residual solvent contained in the magnetic layer is preferably 100 mg/m² or less, more preferably 10 mg/m² or less. The void ratio in the coating layer is preferably 30% by volume or less, preferably 20% by volume or less, in both the nonmagnetic and magnetic layers. Smaller void ratio is preferable to achieve high output, but there are cases where it is more preferable to ensure a certain value depending on the purposes. For example, in disk media in which repeating applications are important, a high void ratio may be often preferable for running durability.

The maximum roughness height. SRz (hereinbelow following JIS B 0601: 2001) of the magnetic layer is preferably 0.5 μm or less. The ten-point average roughness SRzjis is preferably 0.3 μm or less. The center surface peak SRp is preferably 0.3 μm or less. The center surface valley depth SRv is preferably 0.3 μm or less. The center surface area SSr is preferably 20 to 80%. And the average wavelength Ska is preferably 5 to 300 μm. These can be readily controlled by controlling the surface properties by means of fillers used in the support and the surface shape of the rolls employed in calendering. Curling is preferably within ±3 mm.

In the magnetic recording medium of the present invention, when a nonmagnetic layer is provided, it is possible to vary the physical characteristics between the nonmagnetic layer and the magnetic layer depending on the purpose. For example, while increasing the modulus of elasticity of the magnetic layer to improve running durability, it is possible to make the modulus of elasticity of the nonmagnetic layer lower than that of the magnetic layer to enhance contact between the magnetic recording medium and the head.

### [Production Method]

The method for producing the magnetic layer coating liquid for the magnetic recording medium used in the present invention includes at least a kneading step, dispersion step, and mixing steps provided as needed before and after these steps. Each of the steps may be divided into two or more stages.

All of the starting materials employed in the present invention, including the ferrite ferromagnetic hexagonal powder or ferromagnetic metal powder, nonmagnetic powder, benzenesulfonic acid derivatives, π-electron conjugated conducting polymers, binder, carbon black, abrasives, antistatic agents, lubricants and solvents may be added at the beginning or during any step. Further, each of the starting materials may be divided and added during two or more steps. For example, polyurethane may be divided up and added during the kneading step, dispersion step and mixing step for viscosity adjustment after dispersion.

To achieve the object of the present invention, conventionally known manufacturing techniques may be employed for some of the steps. A kneading device of high kneading strength such as an open kneader, continuous kneader, pressure kneader and extruder is preferably used in the kneading step. When a kneader is employed, all or a portion (30% or more of the total binder being preferable) of the magnetic powder or nonmagnetic powder and binder can be kneaded in a proportion of 15 to 500 parts by mass per 100 parts by mass of magnetic material. The details of the kneading process are described in detail in Japanese Patent Application Laid-Open Nos. 1-106338 and 1-79274.

Further, glass beads may be used to disperse the magnetic layer liquid and nonmagnetic liquid. A dispersion medium having a high specific gravity such as zirconia beads, titania beads and steel beads is suitable for use as the glass beads. The particle diameter and filling ratio of the dispersion medium are optimized for use. A known dispersing machine may be used.

In the method for producing the magnetic recording medium of the present invention, the magnetic layer coating liquid is applied to a prescribed film thickness, for example, on the surface of a running nonmagnetic support to form a magnetic layer. In this process, plural magnetic layer coating liquids can be sequentially or simultaneously applied to form a multilayer, and the nonmagnetic layer coating liquid and the magnetic layer coating liquid can be sequentially or simultaneously applied to form a multilayer.

As a coating machines suitable for use in applying the magnetic layer coating liquid or the nonmagnetic layer coating liquid mentioned above, air doctor coater, blade coater, rod coater, extrusion coater, air knife coater, squeeze coater, immersion coater, reverse roll coater, transfer roll coater, gravure coater, kiss coater, cast coater, spray coater, spin coater and the like can be employed. For example, “Recent Coating Techniques” (May 31, 1983), issued by the Sogo Gijutsu Center K.K. may be referred to in this regard.

In the case of a magnetic tape, the layer formed by coating the magnetic layer coating liquid is magnetically oriented in the longitudinal direction using a cobalt magnet or solenoid on the ferromagnetic powder contained in the layer formed by applying the magnetic layer coating liquid.

The temperature and flow rate of drying air and the coating rate are desirably determined to control the drying position of the coated film. The coating rate is preferably from 20 m/min to 1,000 m/min and the temperature of the drying air is preferably 60° C. or more. It is also possible to conduct suitable predrying before entry into the magnet zone.

After drying, the coated layer is subjected to a surface smoothing treatment. For example, supercalender rolls are employed in the surface smoothing treatment. The surface smoothing treatment eliminates holes produced by the removal of solvent during drying and improves the filling ratio of ferromagnetic powder in the magnetic layer, making it possible to obtain a magnetic recording medium of high electromagnetic characteristics. Heat-resistant plastic rolls such as epoxy, polyimide, polyamide and polyamidoimide rolls may be employed as the calendering rolls. Processing with metal rolls is also possible.

The magnetic recording medium of the present invention preferably has an extremely smooth surface. This is achieved, for example, by subjecting a magnetic layer formed by selecting a specific ferromagnetic powder and binder such as have been set forth above to the above-described calendering. Calendering is preferably conducted under conditions of a calendering roll temperature falling within a range of 60 to 100° C., preferably within a range of 70 to 100° C., and particularly preferably within a range of 80 to 100° C., at a pressure (linear pressure) falling within a range of 100 to 500 kg/cm, preferably within a range of 200 to 450 kg/cm, and particularly preferably within a range of 300 to 400 kg/cm.

The method of reducing the thermal shrinkage ratio include heat treatment in a web-shape while handling at low tension and heat treatment (thermo processing) with the tape in bulk or in a stacked state such as wound on a cassette and both may be employed. From the viewpoint of supplying a magnetic recording medium of high output and low noise, thermo processing is desirable.

The magnetic recording medium obtained can be cut to a desired size with a cutter or the like for use.

As described above, according to the present invention, a magnetic recording medium having a magnetic layer formed on at least one surface of a nonmagnetic support, wherein the magnetic layer includes a ferrite ferromagnetic hexagonal powder having an average plate diameter of 5 to 50 nm or a fine ferromagnetic metal powder having an average major axis length of 20 to 100 nm and a binder and the nonmagnetic support is a composition of a polyester or copolyester having one or more of polytrimethylene 2,6-naphthalate, polytetramethylene 2,6-naphthalate, polypentamethylene 2,6-naphthalate and polyhexamethylene 2,6-naphthalate, which can maintain a good error rate under high temperature and high humidity environment, and therefore, remarkable effects can be recognized as compared with the conventional methods.

Examples of embodiments of the magnetic recording media according to the present invention has been described, but the present invention is not limited to the above examples of embodiments and various embodiments can be adopted.

### EXAMPLES

The present invention is described more specifically below through examples. The components, proportions, operations, sequences and the like indicated here can be modified without departing from the spirit or scope of the present invention, and are not to be construed as being limited to the Examples below. Further, unless specifically indicated otherwise, the “parts” indicated in the Examples refer to parts by mass.

### Example 1-1

### [Production of Nonmagnetic Support]

100 parts of dimethyl naphthalene-2,6-dicarboxylate, 74 parts of 1,4-tetramethylene diol and 0.023 part of tetrabutoxytitanium as a catalyst are placed in a reaction container equipped with a distillation apparatus in a nitrogen gas stream at room temperature and subsequently agitated under a nitrogen gas atmosphere at each temperature of 190° C., 200° C., 210° C., 230° C. and 250° C. for one hour respectively to perform transesterification reaction. Then the pressure was reduced to 100 mmHg over 30 minutes and maintained for further 30 minutes and the temperature was further elevated to 280° C. and decompression degree was enhanced to 0.1 mmHg to conduct polycondensation reaction for one hour. After the mixture reached a predetermined melt viscosity, it was made into tips by a conventional method and poly(tetramethylene 2,6-naphthalate) pellets having an intrinsic viscosity of 0.6 was obtained.

After the pellets of poly(tetramethylene 2,6-naphthalate) were dried at 160° C. for four hours, the pellets were supplied to an extruder hopper, melted at the melting temperature of 250° C. extruded onto a turning cooling drum having a skin temperature of 40° C. through a slit die. Subsequently, the product was stretched in the longitudinal direction while heated again at 110° C. with an IR heater and stretched in the lateral direction in a stenter at 110° C., and then heat set at 145° C. for 5 seconds to obtain a film having a film thickness of 5 μm. Young's modulus of the obtained film was 7 GPa in the longitudinal direction and 11 GPa in the lateral direction, and the arithmetical mean roughness (Ra) was 6 nm.

[Preparation of coating liquid for magnetic layer]

| | | |
|---|---|---|
| Ferromagnetism needle-shaped metal powder | 100 | parts |
| Composition: Fe/Co/Al/Y = 67/20/8/5, | | |
| Surface treating agent: Al₂O₃, Y₂O₃ | | |
| Crystallite size: 12.5 nm | | |
| Major axis diameter: 43 nm, needle-shaped ratio: 6 | | |
| BET specific surface area (SBET): 46 m²/g | | |
| Coercive force (Hc): 183 kA/m | | |
| Saturation magnetization (σs): 140 A · m²/kg (140 emu/g) | | |
| Polyurethane resin | 12 | parts |
| Branched side-chain containing polyester polyol/diphenylmethane diisocyanate, | | |
| Hydrophilic polar group: containing 70 eq/ton of —SO₃Na | | |
| Phenylphosphonic acid | 3 | parts |
| α-Al₂O₃ (particle size 0.06 μm) | 2 | parts |
| Carbon black (particle size 20 nm) | 2 | parts |
| Cyclohexanone | 110 | parts |
| Methylethyl ketone | 100 | parts |
| Toluene | 100 | parts |
| Butyl stearate | 2 | parts |
| Stearic acid | 1 | part |

[Preparation of coating liquid for nonmagnetic layer]

| | | |
|---|---|---|
| Nonmagnetic inorganic substance powder | 85 | parts |
| α-iron oxide, Surface treatment agent: Al₂O₃, SiO₂ | | |
| Major axis diameter: 0.15 μm, tap density: 0.8 g/ml | | |
| Needle-shaped ratio: 7, BET specific surface area (SBET): 52 m²/g | | |
| DBP oil absorption: 33 g/100 g, pH 8 | | |
| Carbon black | 20 | parts |
| BET specific surface area: 250 m²/g, DBP oil absorption: 120 ml/100 g | | |
| PH: 8, volatile matter: 1.5% | | |
| Polyurethane resin | 12 | parts |
| Branched side-chain containing polyester polyol/diphenylmethane diisocyanate, | | |
| Hydrophilic polar group: containing 70 eq/ton of —SO₃Na | | |
| Acrylic resin | 6 | parts |
| Benzyl methacrylate/diacetone acrylamide, | | |
| Hydrophilic polar group: containing 60 eq/ton of —SO₃Na | | |
| Phenylphosphonic acid | 3 | parts |
| α-Al₂O₃ (average particle diameter 0.2 μm) | 1 | part |
| Cyclohexanone | 140 | parts |
| Methylethyl ketone | 170 | parts |
| Butyl stearate | 2 | parts |
| Stearic acid | 1 | part |

The individual components of the above-described composition of the magnetic layer (upper layer) coating liquid and composition of the nonmagnetic layer (lower layer) coating liquid were kneaded for 60 min in an open kneader and then dispersed for 120 min in a sand mill. Six parts of trifunctional low-molecular-weight polyisocyanate compound (Coronate 3041 made by Nippon Polyurethane) were added to the dispersions obtained, mixing was conducted for a further 20 min with stirring, and the mixture was filtered through a filter having an average pore diameter of 1 μm to prepare a magnetic layer coating liquid and a nonmagnetic layer coating liquid.

The above-described nonmagnetic layer coating liquid was then applied in a quantity calculated to yield a dry thickness of 1.5 μm, and immediately thereafter, the above-described magnetic layer coating liquid was applied in a quantity calculated to yield a dry thickness of 0.1 μm by a simultaneous multilayer coating on the above support. While the magnetic layer and the nonmagnetic layer were still wet, magnetic orientation was conducted with a 300 T·m (3000 gauss) magnet, the layers were dried, surface smoothing treatment was conducted at 90° C. at a linear pressure of 300 kg/cm, a heat treatment was conducted at 70° C. for 48 hours, and the film was slit to a 12.7 mm (½-inch) width to prepare magnetic tape.

### Example 1-2

Example 1-2 was performed in the same process as in Example 1 except that 1,4-tetramethylene diol was replaced with 1,6-hexamethylene diol to synthesize polyhexamethylene 2,6-naphthalate.

### Examples 1-3, 1-4

Example 1-3 and Example 1-4 were performed in the same process as in Example 1-1 and 1-2 except that polytetramethylene 2,6-naphthalate and polyhexamethylene 2,6-naphthalate pellets obtained in. Example 1-1 and Example 1-2 were mixed with polyethylene naphthalate pellet at a mixing ratio of 80/20 to form a film.

### Comparative Example 1-1

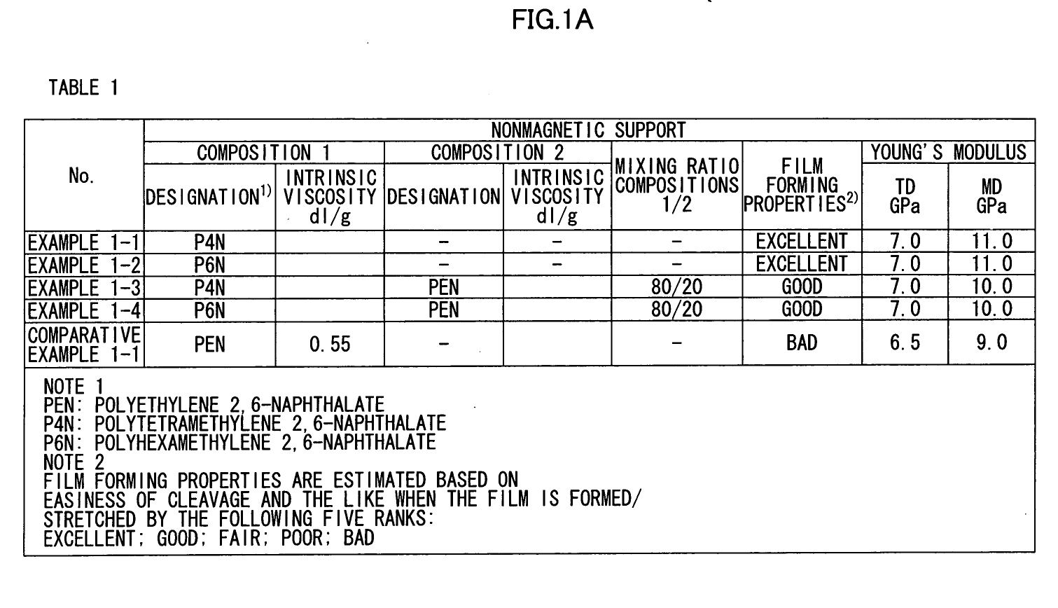

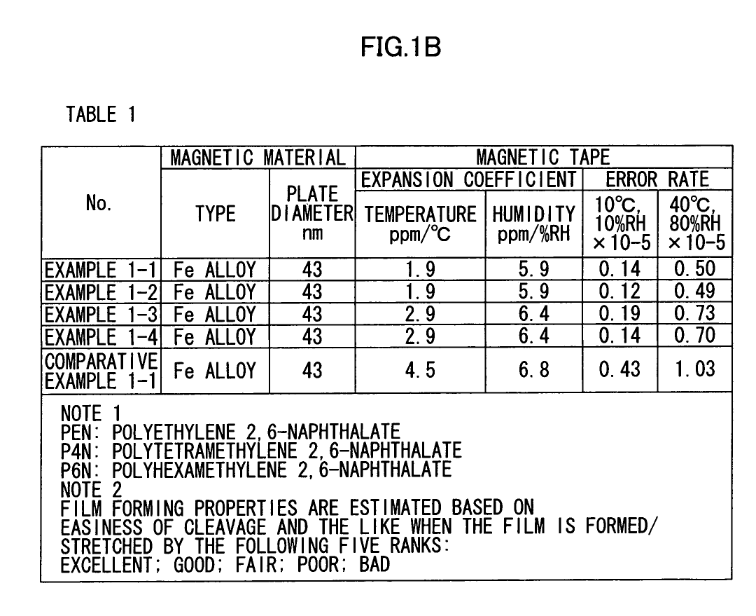

The nonmagnetic support was changed to one shown in table 1 of FIGS. 1A and 1B and Comparative Example 1-1 was performed in the same process as in Example 1-1.

### Examples 2-1 to 2-4, Comparative Example 2-1

[Preparation of magnetic layer coating liquid]

| | | |
|---|---|---|
| Ferromagnetism tabular hexagonal crystal ferrite powder | 100 | parts |
| Composition (Molar ratio): Ba/Fe/Co/Zn = 1/9/0.2/0.8 | | |
| Plate diameter: 30 nm, tabular ratio: 3, BET specific surface | | |
| area: 50 m²/g | | |
| Coercive force (Hc): 191 kA/m | | |
| Saturation magnetization (σs): 60 A/m²/kg | | |
| Polyurethane resin | 12 | parts |
| Branched side-chain containing polyester polyol/ | | |
| diphenylmethane diisocyanate, | | |
| Hydrophilic polar group: containing 70 eq/ton of —SO₃Na | | |
| Phenylphosphonic acid | 3 | parts |
| α-Al₂O₃ (average particle diameter 0.15 μm) | 2 | parts |
| Carbon black (Particle size 20 nm) | 2 | parts |
| Cyclohexanone | 110 | parts |
| Methylethyl ketone | 100 | parts |
| Toluene | 100 | parts |
| Butyl Stare rate | 2 | parts |
| Stearic acid | 1 | part |

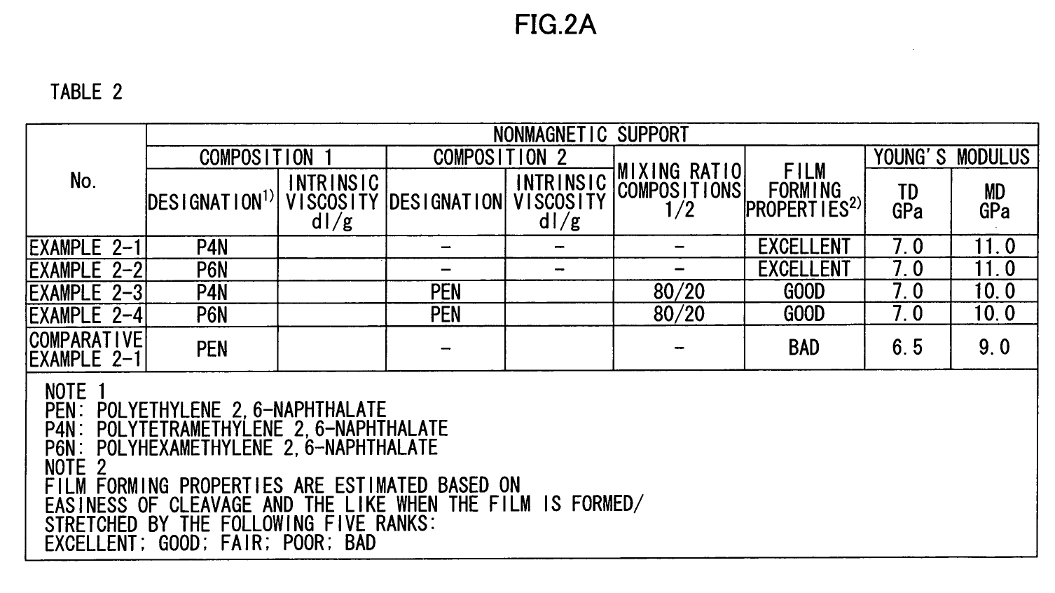

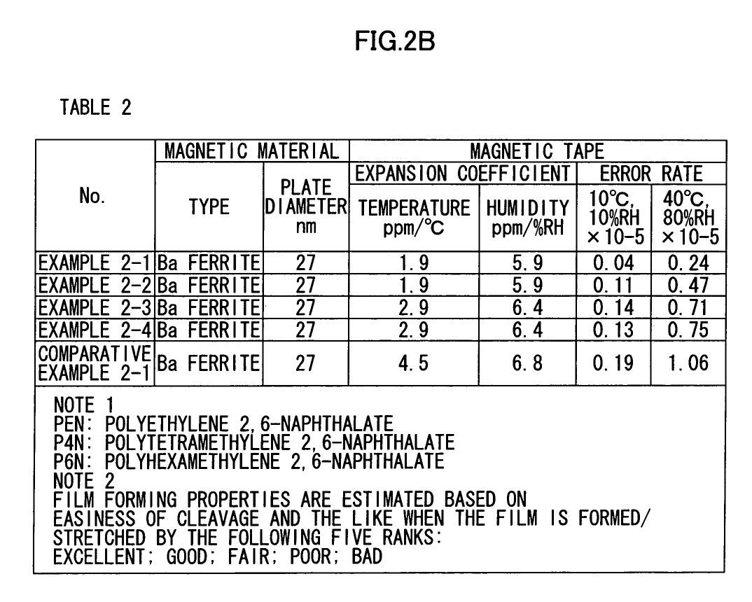

The magnetic material was changed to one shown in Table 2 of FIGS. 2A and 2B and a magnetic tape was made in the same process as in Example 1-1.

### <Measuring Method>

### 1. Measurement of Intrinsic Viscosity

Polyester film was dissolved in a mixed solvent of phenol/1,1,2,2-tetrachloroethane=60/40 (weight ratio) and measured at 25° C. in the automatic viscometer set with Ubbelohde viscometer.

### 2. Measurement of Tensile Characteristics (Young's Modulus)

Measurement was performed using a strograph V1-C type tensile testing machine manufactured by Toyo Seiki Seisaku-Sho, according to a method prescribed in JIS K 7113 (1995) by measuring a sample piece of 100 mm in length and 5 mm in width with a tensile rate of 100 mm/min under environment of 25° C., 50% RH.

### 3. Measurement of Temperature-Humidity Expansion Coefficient

Stress of 1.0 N was applied on a tape of 12.7 mm (½ inch) using Transverse Dimensional Stability Measurement System TDSMS Model 102 manufactured by MEASUREMENT ANALYSIS CORP. (TORRANCE, CA, USA), and the amount of deformation in the width direction was determined under environment of 45° C. and 10% RH, 10C and 10% RH, 29° C. and 80% RH, and 45° C. and 24% RH, and temperature coefficient of expansion and humidity coefficient of expansion were respectively calculated by multiple regression analysis.

### 4. Measurement of Error Rate (Under Normal Environment and Environment of High Humidity and High Temperature)

Recorded signals were recorded by 8-10 conversion PR1 equalization method at 25° C. and regenerated under environment of 50% RH and 30° C. and 80% RH to determine the error rate.

### Comparison of Examples and Comparative Examples

The production conditions and results of evaluation of respective Examples and Comparative Examples described above were summarized in the tables of FIGS. 1A, 1B, 2A and 2B.

According to the tables of FIGS. 1A, 1B, 2A and 2B, the effect of the present invention was confirmed because each Example, in which the nonmagnetic support is a composition of a polyester or copolyester having one or more of poly(trimethylene 2,6-naphthalate), poly(tetramethylene 2,6-naphthalate), poly(pentamethylene 2,6-naphthalate) and poly(hexamethylene 2,6-naphthalate), exhibits low error rates.

In contrast, it was confirmed that no such a low error rate as in Examples was attained in each Comparative Example having conditions different from those of Examples.

What is claimed is:

1. A magnetic recording medium having a magnetic layer formed on at least one surface of a nonmagnetic support, wherein
the magnetic layer includes a ferrite ferromagnetic hexagonal powder having an average plate diameter of 5 to 50 nm or a fine ferromagnetic metal powder having an average major axis length of 20 to 100 nm together with a binder, and
the nonmagnetic support is a composition of a polyester or copolyester having one or more of polytrimethylene 2,6-naphthalate, polytetramethylene 2,6-naphthalate, polypentamethylene 2,6-naphthalate and polyhexamethylene 2,6-naphthalate.

2. The magnetic recording medium according to claim 1, wherein
the nonmagnetic support includes 1 to 40% by weight of polyethylene 2,6-naphthalate.

3. The magnetic recording medium according to claim 1, wherein
the nonmagnetic support has a Young's modulus in the length direction of 6.0 to 11.0 GPa and a Young's modulus in the width direction of 6.0 to 11.0 GPa.

4. The magnetic recording medium according to claim 2, wherein
the nonmagnetic support has a Young's modulus in the length direction of 6.0 to 11.0 GPa and a Young's modulus in the width direction of 6.0 to 11.0 GPa.

5. The magnetic recording medium according to claim 1, wherein
the nonmagnetic support has a temperature expansion coefficient of 0 to 20 ppm/° C. and a humidity expansion coefficient of 0 to 20 ppm/% RH.

6. The magnetic recording medium according to claim 2, wherein
the nonmagnetic support has a temperature expansion coefficient of 0 to 20 ppm/° C. and a humidity expansion coefficient of 0 to 20 ppm/% RH.

7. The magnetic recording medium according to claim 3, wherein
the nonmagnetic support has a temperature expansion coefficient of 0 to 20 ppm/° C. and a humidity expansion coefficient of 0 to 20 ppm/% RH.

8. The magnetic recording medium according to claim 4, wherein
the nonmagnetic support has a temperature expansion coefficient of 0 to 20 ppm/° C. and a humidity expansion coefficient of 0 to 20 ppm/% RH.

9. The magnetic recording medium according to claim 1, wherein
the medium has a nonmagnetic layer including a nonmagnetic powder and a binder, between the nonmagnetic support and the magnetic layer.

10. The magnetic recording medium according to claim 2, wherein
the medium has a nonmagnetic layer including a nonmagnetic powder and a binder, between the nonmagnetic support and the magnetic layer.

11. The magnetic recording medium according to claim 3, wherein
the medium has a nonmagnetic layer including a nonmagnetic powder and a binder, between the nonmagnetic support and the magnetic layer.

12. The magnetic recording medium according to claim 4, wherein
the medium has a nonmagnetic layer including a nonmagnetic powder and a binder, between the nonmagnetic support and the magnetic layer.

13. The magnetic recording medium according to claim 5, wherein
the medium has a nonmagnetic layer including a nonmagnetic powder and a binder, between the nonmagnetic support and the magnetic layer.

14. The magnetic recording medium according to claim 6, wherein
the medium has a nonmagnetic layer including a nonmagnetic powder and a binder, between the nonmagnetic support and the magnetic layer.

15. The magnetic recording medium according to claim 7, wherein
the medium has a nonmagnetic layer including a nonmagnetic powder and a binder, between the nonmagnetic support and the magnetic layer.

16. The magnetic recording medium according to claim 8, wherein
the medium has a nonmagnetic layer including a nonmagnetic powder and a binder, between the nonmagnetic support and the magnetic layer.
